(19) United States
(12) Patent Application Publication
(10) Pub. No.: US 2025/0023622 A1
(43) Pub. Date: Jan. 16, 2025

(54) RESOURCE CONFIGURATION FOR SCHEDULING REQUESTS FOR MULTIPLE NODE BEAM FAILURE RECOVERY

(71) Applicant: QUALCOMM Incorporated, San Diego, CA (US)

(72) Inventors: Ruiming ZHENG, Beijing (CN); Yan ZHOU, San Diego, CA (US); Ozcan OZTURK, San Diego, CA (US); Linhai HE, San Diego, CA (US); Tao LUO, San Diego, CA (US)

(21) Appl. No.: 18/713,924

(22) PCT Filed: Jan. 6, 2022
(86) PCT No.: PCT/CN2022/070449

§ 371 Date: May 28, 2024

(51) Int. Cl. H04B 7/06

(52) U.S. Cl. CPC H04B 7/06964

(57) ABSTRACT

Various aspects of the present disclosure generally relate to wireless communication. In some aspects, a user equipment (UE) may receive configuration information identifying a first scheduling request (SR) configuration associated with beam failure recovery (BFR) and a second SR configuration associated with BFR. The UE may detect a first beam failure associated with a first communication node. The UE may transmit a first SR on a first SR resource indicated by the first SR configuration based at least in part on detecting the first beam failure associated with the first communication node. The UE may detect a second beam failure associated with a second communication node. The UE may selectively transmit a second SR on a second SR resource indicated by the second SR configuration based at least in part on detecting the second beam failure associated with the second communication node and the configuration information. Other aspects are described.

### FIELD OF THE DISCLOSURE

Aspects of the present disclosure generally relate to wireless communication and to techniques and apparatuses for resource configuration for scheduling requests for multiple node beam failure recovery.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example logical architecture of a distributed RAN, in accordance with the present disclosure.

FIG. 4 is a diagram illustrating an example of multiple transmit receive point (TRP) communication, in accordance with the present disclosure.

FIG. 5 is a diagram illustrating an example of TRP differentiation at a UE based at least in part on a control resource set (CORESET) pool index, in accordance with the present disclosure.

FIG. 6 is a diagram illustrating an example of beam failure recovery (BFR) associated with a primary cell (PCell) and a secondary cell (SCell), in accordance with the present disclosure.

FIG. 7 is a diagram illustrating an example of signaling associated with multi-TRP BFR, in accordance with the present disclosure.

FIG. 8 is a diagram illustrating an example process performed, for example, by a user equipment (UE), in accordance with the present disclosure.

FIG. 9 is a diagram illustrating an example process performed, for example, by a base station, in accordance with the present disclosure.

FIG. 10 is a diagram of an example apparatus for wireless communication, in accordance with the present disclosure.

FIG. 11 is a diagram of an example apparatus for wireless communication, in accordance with the present disclosure.

### SUMMARY

Some aspects described herein relate to a method of wireless communication performed by a user equipment (UE). The method may include receiving configuration information identifying a first scheduling request (SR) configuration associated with beam failure recovery (BFR) and a second SR configuration associated with BFR. The method may include detecting a first beam failure associated with a first communication node. The method may include transmitting a first SR on a first SR resource indicated by the first SR configuration based at least in part on detecting the first beam failure associated with the first communication node. The method may include detecting a second beam failure associated with a second communication node. The method may include selectively transmitting a second SR on a second SR resource indicated by the second SR configuration based at least in part on detecting the second beam failure associated with the second communication node and the configuration information.

Some aspects described herein relate to a method of wireless communication performed by a base station. The method may include transmitting configuration information identifying a first SR configuration associated with BFR and a second SR configuration associated with BFR. The method may include receiving a first SR on a first SR resource indicated by the first SR configuration based at least in part on a beam failure associated with a first communication node of the base station. The method may include selectively receiving a second SR on a second SR resource indicated by the second SR configuration based at least in part on a second beam failure associated with a second communication node of the base station, and based at least in part on the configuration information.

Some aspects described herein relate to a UE for wireless communication. The user equipment may include a memory and one or more processors coupled to the memory. The one or more processors may be configured to receive configuration information identifying a first SR configuration associated with BFR and a second SR configuration associated with BFR. The one or more processors may be configured to detect a first beam failure associated with a first communication node. The one or more processors may be configured to transmit a first SR on a first SR resource indicated by the first SR configuration based at least in part on detecting the first beam failure associated with the first communication node. The one or more processors may be configured to detect a second beam failure associated with a second communication node. The one or more processors may be configured to selectively transmit a second SR on a second SR resource indicated by the second SR configuration based at least in part on detecting the second beam failure associated with the second communication node and the configuration information.

Some aspects described herein relate to a base station for wireless communication. The base station may include a memory and one or more processors coupled to the memory. The one or more processors may be configured to transmit configuration information identifying a first SR configuration associated with BFR and a second SR configuration associated with BFR. The one or more processors may be configured to receive a first SR on a first SR resource indicated by the first SR configuration based at least in part on a beam failure associated with a first communication node of the base station. The one or more processors may be configured to selectively receive a second SR on a second SR resource indicated by the second SR configuration based at least in part on a second beam failure associated with a second communication node of the base station, and based at least in part on the configuration information.

Some aspects described herein relate to a non-transitory computer-readable medium that stores a set of instructions for wireless communication by a UE. The set of instructions, when executed by one or more processors of the UE, may cause the UE to receive configuration information identifying a first SR configuration associated with BFR and a second SR configuration associated with BFR. The set of instructions, when executed by one or more processors of the UE, may cause the UE to detect a first beam failure associated with a first communication node. The set of instructions, when executed by one or more processors of the UE, may cause the UE to transmit a first SR on a first SR resource indicated by the first SR configuration based at least in part on detecting the first beam failure associated with the first communication node. The set of instructions, when executed by one or more processors of the UE, may cause the UE to detect a second beam failure associated with a second communication node. The set of instructions, when executed by one or more processors of the UE, may cause the UE to selectively transmit a second SR on a second SR resource indicated by the second SR configuration based at least in part on detecting the second beam failure associated with the second communication node and the configuration information.

Some aspects described herein relate to a non-transitory computer-readable medium that stores a set of instructions for wireless communication by a base station. The set of instructions, when executed by one or more processors of the base station, may cause the base station to transmit configuration information identifying a first SR configuration associated with BFR and a second SR configuration associated with BFR. The set of instructions, when executed by one or more processors of the base station, may cause the base station to receive a first SR on a first SR resource indicated by the first SR configuration based at least in part on a beam failure associated with a first communication node of the base station. The set of instructions, when executed by one or more processors of the base station, may cause the base station to selectively receive a second SR on a second SR resource indicated by the second SR configuration based at least in part on a second beam failure associated with a second communication node of the base station, and based at least in part on the configuration information.

Some aspects described herein relate to an apparatus for wireless communication. The apparatus may include means for receiving configuration information identifying a first SR configuration associated with BFR and a second SR configuration associated with BFR. The apparatus may include means for detecting a first beam failure associated with a first communication node. The apparatus may include means for transmitting a first SR on a first SR resource indicated by the first SR configuration based at least in part on detecting the first beam failure associated with the first communication node. The apparatus may include means for detecting a second beam failure associated with a second communication node. The apparatus may include means for selectively transmitting a second SR on a second SR resource indicated by the second SR configuration based at least in part on detecting the second beam failure associated with the second communication node and the configuration information.

Some aspects described herein relate to an apparatus for wireless communication. The apparatus may include means for transmitting configuration information identifying a first SR configuration associated with BFR and a second SR configuration associated with BFR. The apparatus may include means for receiving a first SR on a first SR resource indicated by the first SR configuration based at least in part on a beam failure associated with a first communication node of the base station. The apparatus may include means for selectively receiving a second SR on a second SR resource indicated by the second SR configuration based at least in part on a second beam failure associated with a second communication node of the base station, and based at least in part on the configuration information.

Aspects generally include a method, apparatus, system, computer program product, non-transitory computer-readable medium, user equipment, base station, wireless communication device, and/or processing system as substantially described herein with reference to and as illustrated by the drawings.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

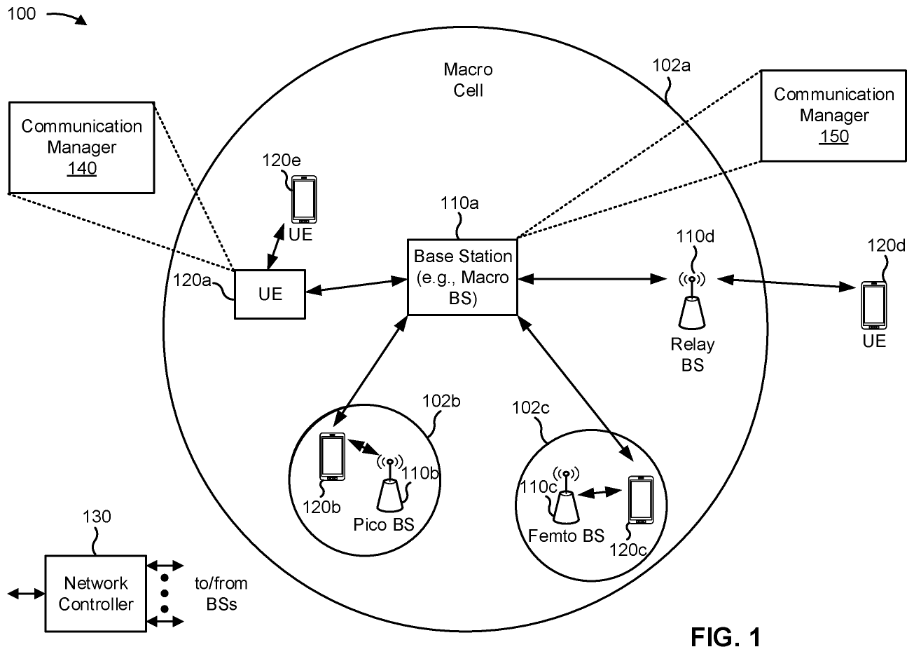

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive configuration information identifying a first scheduling request (SR) configuration associated with beam failure recovery (BFR) and a second SR configuration associated with BFR; detect a first beam failure associated with a first communication node; transmit a first SR on a first SR resource indicated by the first SR configuration based at least in part on detecting the first beam failure associated with the first communication node; detect a second beam failure associated with a second communication node; and selectively transmit a second SR on a second SR resource indicated by the second SR configuration based at least in part on detecting the second beam failure associated with the second communication node and the configuration information. Additionally, or alternatively, the communication manager 140 may perform one or more other operations described herein.

In some aspects, the base station 110 may include a communication manager 150. As described in more detail elsewhere herein, the communication manager 150 may transmit configuration information identifying a first scheduling request (SR) configuration associated with beam failure recovery (BFR) and a second SR configuration associated with BFR; receive a first SR on a first SR resource indicated by the first SR configuration based at least in part on a beam failure associated with a first communication node of the base station; and selectively receive a second SR on a second SR resource indicated by the second SR configuration based at least in part on a second beam failure associated with a second communication node of the base station, and based at least in part on the configuration information. Additionally, or alternatively, the communication manager 150 may perform one or more other operations described herein.

As indicated above, FIG. 1 is provided as an example. Other examples may differ from what is described with regard to FIG. 1.

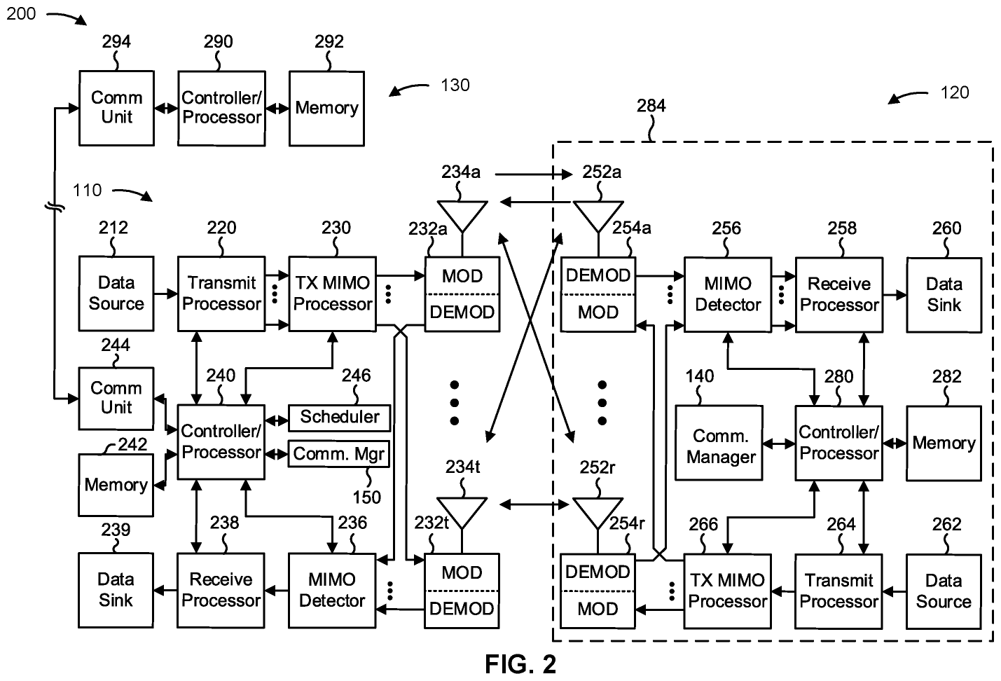

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

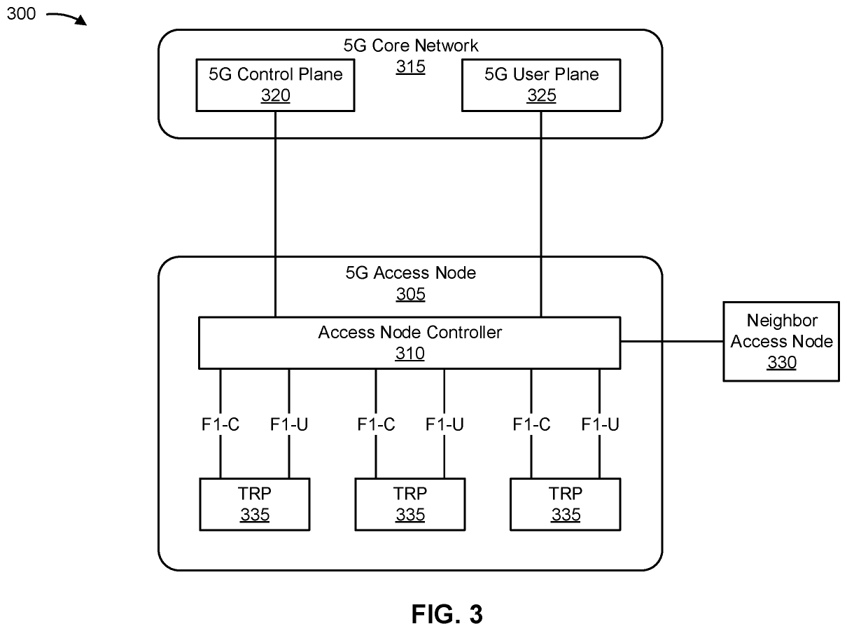

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 3-11).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 3-11).

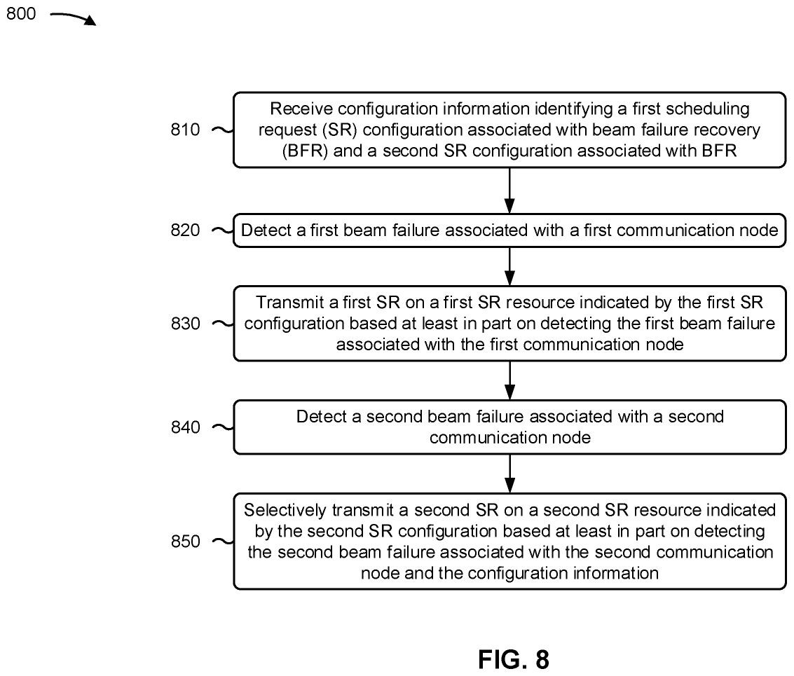

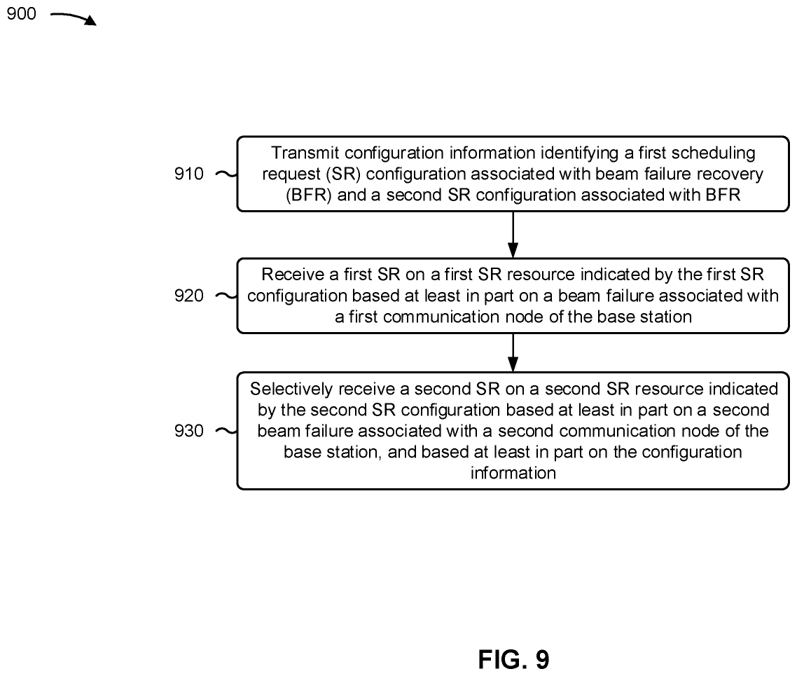

The controller/processor 240 of the base station 110, the controller/processor 280 of the UE 120, and/or any other component(s) of FIG. 2 may perform one or more techniques associated with scheduling requests for multi-TRP communication, as described in more detail elsewhere herein. For example, the controller/processor 240 of the base station 110, the controller/processor 280 of the UE 120, and/or any other component(s) of FIG. 2 may perform or direct operations of, for example, process 800 of FIG. 8, process 900 of FIG. 9, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 800 of FIG. 8, process 900 of FIG. 9, and/or other processes as described herein. In some examples, executing instructions may include running the instructions, converting the instructions, compiling the instructions, and/or interpreting the instructions, among other examples.

In some aspects, the UE includes means for receiving configuration information identifying a first SR configuration associated with BFR and a second SR configuration associated with BFR; means for detecting a first beam failure associated with a first communication node; means for transmitting a first SR on a first SR resource indicated by the first SR configuration based at least in part on detecting the first beam failure associated with the first communication node; means for detecting a second beam failure associated with a second communication node; and/or means for selectively transmitting a second SR on a second SR resource indicated by the second SR configuration based at least in part on detecting the second beam failure associated with the second communication node and the configuration information. The means for the user equipment (UE) to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting configuration information identifying a first SR configuration associated with BFR and a second SR configuration associated with BFR; means for receiving a first SR on a first SR resource indicated by the first SR configuration based at least in part on a beam failure associated with a first communication node of the base station; and/or means for selectively receiving a second SR on a second SR resource indicated by the second SR configuration based at least in part on a second beam failure associated with a second communication node of the base station, and based at least in part on the configuration information. The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

FIG. 3 illustrates an example logical architecture of a distributed RAN 300, in accordance with the present disclosure.

A 5G access node 305 may include an access node controller 310. The access node controller 310 may be a central unit (CU) of the distributed RAN 300. In some aspects, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some aspects, a TRP 335 may correspond to a base station 110 described above in connection with FIG. 1. For example, different TRPs 335 may be included in different base stations 110. Additionally, or alternatively, multiple TRPs 335 may be included in a single base station 110. In some aspects, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some aspects, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some aspects, multiple TRPs 335 may transmit communications (e.g., the same communication or different communications) in the same transmission time interval (TTI) (e.g., a slot, a mini-slot, a subframe, or a symbol) or different TTIs using different quasi-colocation (QCL) relationships (e.g., different spatial parameters, different transmission configuration indicator (TCI) states, different precoding parameters, and/or different beamforming parameters). In some aspects, a TCI state may be used to indicate one or more QCL relationships. A TRP 335 may be configured to individually (e.g., using dynamic selection) or jointly (e.g., using joint transmission with one or more other TRPs 335) serve traffic to a UE 120. A QCL relationship may be referred to herein as a spatial relation.

In some aspects, TRPs 335 may communicate using beamforming. A beam may fail due to changing channel conditions, UE orientation, or the like. Beam failure detection (BFD) and beam failure recover (BFR) provide ways for a UE to detect and recover from a failed beam. Techniques described herein provide signaling and resource configuration for scheduling request (SR) resources related to BFR procedures.

As indicated above, FIG. 3 is provided as an example. Other examples may differ from what was described with regard to FIG. 3.

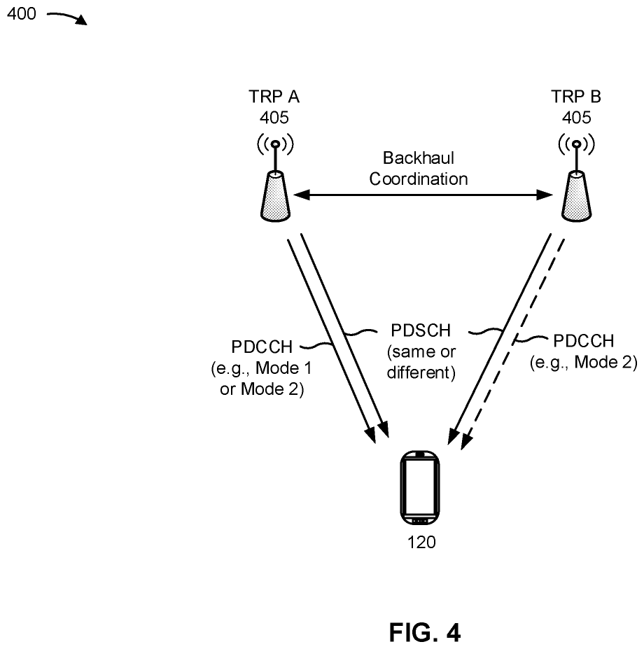

FIG. 4 is a diagram illustrating an example 400 of multi-TRP communication (sometimes referred to as multi-panel communication), in accordance with the present disclosure. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (e.g., using coordinated multipoint transmissions) to improve reliability and/or increase throughput. The TRPs 405 may coordinate such communications via an interface between the TRPs 405 (e.g., a backhaul interface and/or an access node controller 310). The interface may have a smaller delay and/or higher capacity when the TRPs 405 are co-located at the same base station 110 (e.g., when the TRPs 405 are different antenna arrays or panels of the same base station 110), and may have a larger delay and/or lower capacity (as compared to co-location) when the TRPs 405 are located at different base stations 110. The different TRPs 405 may communicate with the UE 120 using different QCL relationships (e.g., different TCI states), different demodulation reference signal (DMRS) ports, and/or different layers (e.g., of a multi-layer communication).

In a first multi-TRP transmission mode (e.g., Mode 1), a single physical downlink control channel (PDCCH) may be used to schedule downlink data communications for a single physical downlink shared channel (PDSCH). In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some aspects, a TCI state in downlink control information (DCI) (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 405, and a second PDCCH may schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

In some aspects, TRPs 405 may communicate using beamforming. A beam may fail due to changing channel conditions, UE orientation, or the like. Beam failure detection (BFD) and beam failure recover (BFR) provide ways for a UE to detect and recover from a failed beam. Techniques described herein provide signaling and resource configuration for scheduling request (SR) resources related to BFR procedures.

As indicated above, FIG. 4 is provided as an example. Other examples may differ from what is described with respect to FIG. 4.

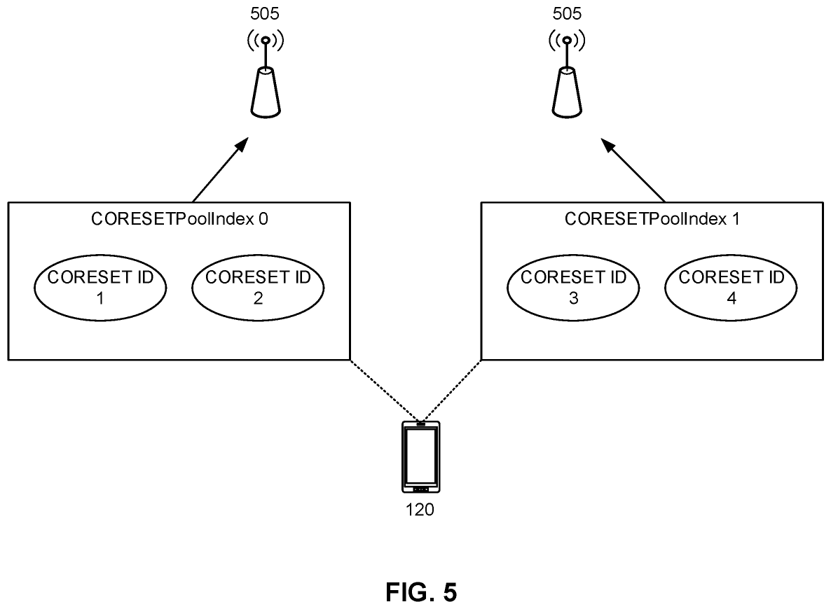

FIG. 5 is a diagram illustrating an example 500 of TRP differentiation at a UE based at least in part on a control resource set (CORESET) pool index, in accordance with the present disclosure. In some aspects, a CORESET pool index (or CORESETPoolIndex) value may be used by a UE (a UE 120) to identify a TRP associated with an uplink grant received on a PDCCH.

A CORESET may refer to a control region that is structured to support an efficient use of resources, such as by flexible configuration or reconfiguration of resources for one or more PDCCHs associated with a UE. In some aspects, a CORESET may occupy the first symbol of an orthogonal frequency division multiplexing (OFDM) slot, the first two symbols of an OFDM slot, or the first three symbols of an OFDM slot. Thus, a CORESET may include multiple resource blocks (RBs) in the frequency domain, and either one, two, or three symbols in the time domain. In 5G, a quantity of resources included in a CORESET may be flexibly configured, such as by using radio resource control (RRC) signaling to indicate a frequency domain region (for example, a quantity of resource blocks) or a time domain region (for example, a quantity of symbols) for the CORESET.

As illustrated in FIG. 5, a UE 120 may be configured with multiple CORESETs in a given serving cell. Each CORESET configured for the UE 120 may be associated with a CORESET identifier (CORESET ID). For example, a first CORESET configured for the UE 120 may be associated with CORESET ID 1, a second CORESET configured for the UE 120 may be associated with CORESET ID 2, a third CORESET configured for the UE 120 may be associated with CORESET ID 3, and a fourth CORESET configured for the UE 120 may be associated with CORESET ID 4.

As further illustrated in FIG. 5, two or more (for example, up to five) CORESETs may be grouped into a CORESET pool. Each CORESET pool may be associated with a CORESET pool index. As an example, CORESET ID 1 and CORESET ID 2 may be grouped into CORESET pool index 0, and CORESET ID 3 and CORESET ID 4 may be grouped into CORESET pool index 1. In a multi-TRP configuration, each CORESET pool index value may be associated with a particular TRP 505. As an example, and as illustrated in FIG. 5, a first TRP 505 (TRP A) may be associated with CORESET pool index 0 and a second TRP 505 (TRP B) may be associated with CORESET pool index 1. The UE 120 may be configured by a higher layer parameter, such as PDCCH-Config, with information identifying an association between a TRP and a CORESET pool index value assigned to the TRP. Accordingly, the UE may identify the TRP that transmitted a DCI uplink grant by determining the CORESET ID of the CORESET in which the PDCCH carrying the DCI uplink grant was transmitted, determining the CORESET pool index value associated with the CORESET pool in which the CORESET ID is included, and identifying the TRP associated with the CORESET pool index value.

As indicated above, FIG. 5 is provided as an example. Other examples may differ from what is described with respect to FIG. 5.

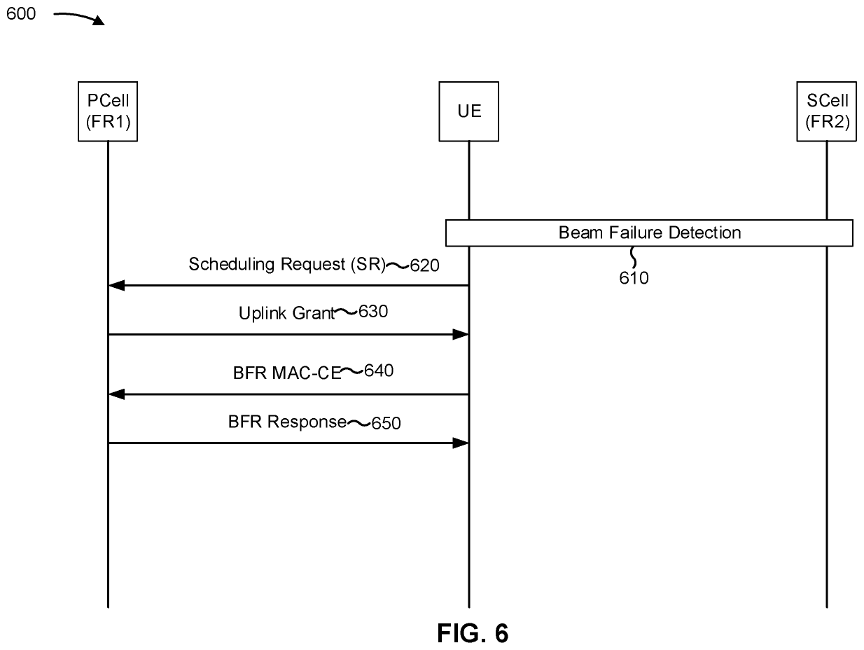

FIG. 6 is a diagram illustrating an example 600 of beam failure recovery (BFR) associated with a primary cell (PCell) and a secondary cell (SCell), in accordance with the present disclosure. A UE (e.g., UE 120) may connect to one or more cells, such as using dual connectivity. The PCell may be a cell in which the UE either performs an initial connection establishment procedure or initiates a connection re-establishment procedure. For example, the PCell may handle signaling, such as RRC signaling, associated with the UE. In some aspects, the PCell may be a cell indicated as the primary cell during a handover procedure. The PCell may also be referred to as a special cell (SpCell). The SCell may be a cell which may be configured to provide additional radio resources to the UE. In some aspects, the PCell and the one or more SCells may each be considered serving cells. In some aspects, an SCell may also handle signaling, and may be referred to as a primary secondary cell (PSCell). A PSCell may be considered an SpCell. For example, “SpCell” may refer to a PCell of a master cell group or a PSCell of a secondary cell group, or to the PCell. An SPCell is a cell on which a UE can transmit or receive control signaling, random access channel messages, or the like.

In example 600, the UE is associated with a PCell and an SCell. In some aspects, the PCell is in a first FR (e.g., FR1) and the SCell is in a second FR (e.g., FR2). In some other aspects, the PCell and the SCell are in the same FR. In some aspects, the PCell is provided by a first communication node (e.g., a first TRP) and the SCell is provided by a second communication node (e.g., a second TRP). In some other aspects, the PCell and the SCell are provided by the same communication node. In other words, example 600 is an example of BFR for a PCell and an SCell irrespective of whether the PCell and the SCell are provided by the same communication node or different communication node.

As shown by reference number 610, the UE may detect beam failure associated with the SCell. For example, the UE may detect that all downlink control beams have failed for the SCell, such as based at least in part on counting beam failure instances associated with the downlink control beams. Detecting that all downlink control beams have failed may be referred to as beam failure detection (BFD). The UE (e.g., a medium access control entity of the UE) may be configured, via radio resource control (RRC) signaling, with a beam failure recovery procedure. The beam failure recovery procedure may be configured per serving cell. The beam failure recovery procedure may be used to indicate, to a serving gNB (e.g., a serving base station), a new synchronization signal block (SSB) or channel state information reference signal (CSI-RS), such as via candidate beam information, when beam failure is detected on a serving beam (e.g., a serving SSB or a serving CSI-RS. For an SpCell BFR, the UE may initiate a random access channel (RACH) procedure for BFR.

As shown by reference number 620, the UE may transmit a scheduling request (SR) on the PCell. The SR may request a grant of uplink resources on which the UE can transmit a BFR medium access control (MAC) control element (CE) (MAC-CE). The BFR MAC-CE is a MAC-CE that carries beam failure information. Beam failure information may indicate, for example, an identifier of the SCell (e.g., a failed SCell instance), an indication of one or more beams that have failed, candidate beam information (e.g., information indicating one or more candidate beams for BFR on the SCell), or the like. As described in more detail below, the SR may be transmitted on an SR resource. As shown by reference number 630, the UE may receive an uplink grant based at least in part on the SR.

As shown by reference number 640, the UE may transmit a BFR MAC-CE. For example, the UE may transmit the BFR MAC-CE on an uplink resource indicated by the uplink grant. In some aspects, the UE may transmit the BFR MAC-CE based at least in part on evaluation of candidate beams for the SCell. For example, if the UE determines that at least one BFR has been triggered and not cancelled for an SCell for which evaluation of candidate beams has been completed, and if uplink shared channel (UL-SCH) resources are available for a new transmission and if the UL-SCH resources can accommodate the BFR MAC-CE plus the BFR MAC-CE's subheader as a result of logical channel prioritization (LCP), then the UE (e.g., the UE's multiplexing and assembly procedure) may generate the BFR MAC CE. If the UL-SCH resources cannot accommodate the BFR MAC-CE plus the subheader, if UL-SCH resources are available for a new transmission, and if the UL-SCH resources can accommodate a truncated BFR MAC-CE plus the truncated BFR MAC-CE's subheader as a result of LCP, then the UE (e.g., the UE's multiplexing and assembly procedure) may generate the truncated BFR MAC CE. If neither of the above conditions is satisfied, the UE may trigger an SR for SCell beam failure recovery for each SCell for which BFR has been triggered, not cancelled, and for which evaluation of the candidate beams has been completed. All BFRs triggered for an SCell may be cancelled when a MAC protocol data unit (PDU) is transmitted and this PDU includes a BFR MAC CE or truncated BFR MAC CE which contains beam failure information of that SCell. As shown by reference number 650, the UE may receive a BFR response from the PCell, which may acknowledge reception of the BFR MAC-CE.

As mentioned above, the SR may be transmitted on an SR resource, such as a physical uplink control channel (PUCCH) associated with an SR (sometimes referred to as a PUCCH-SR). The SR resource may be indicated by an SR resource configuration. In some examples, a single dedicated SR resource configuration, corresponding to BFR for the SCell, may be configured per MAC cell group. A MAC cell group may be a master cell group or a secondary cell group. In some examples, a dedicated SR resource configuration may support one or two PUCCH resources for SR, where each PUCCH resource is associated with a corresponding spatial relation. For example, the PUCCH resources can be configured under a single SR resource configuration with two PUCCH resource identifiers, or under a single SR resource configuration with a single PUCCH resource identifier indicating two spatial relations. In some examples, the UE may be configured with two dedicated SR resource configurations for multi-TRP BFR. For example, each dedicated SR resource configuration may be conveyed via a respective scheduling request resource configuration (e.g., SchedulingRequestResourceConfig) information element (IE). A first SR configuration and a second SR configuration may include separate sets of SR parameters, such as a prohibit timer (e.g., sr-ProhibitTimer) and a maximum number of SR transmissions (e.g., sr-TransMax), and may be associated with a single SR resource corresponding to one of the two dedicated SR resource configurations and a corresponding spatial relation.

If one dedicated SR resource configuration for multi-TRP BFR is configured and is associated with two PUCCH-SR resources, the UE may transmit the SR via the PUCCH resource in the workable TRP (i.e., the non-failed TRP with the workable PUCCH resource) to request an uplink grant. For example, if BFD is detected in the first TRP, the UE may transmit an SR via the PUCCH resource with the spatial relation towards the second TRP for beam failure recovery. If two dedicated SR resource configurations for multi-TRP BFR are configured, the UE may transmit the SR from one of the SR resources configured by the two SR resource configurations. The BFR MAC CE may include a failed TRP index and may indicate UE preferred new beam, and may be transmitted via the granted uplink resource. For SpCell BFR, if beam failure is detected in a first TRP and BFR is triggered, the beam failure recovery procedure can be performed through a second TRP instead of using RACH. If BFD is detected on both TRPs on an SpCell, the UE may perform RACH to recover the beam.

The usage of two dedicated SR configurations may impact multi-TRP BFR signaling. For example, consider a case where a UE sends an SR on a first SR resource based at least in part on detecting beam failure on an SCell or a SpCell of a first TRP. The UE may subsequently detect beam failure of a second TRP for the same SCell or a different SCell before receiving a valid granted uplink resource for transmission of the BFR MAC CE. In this example, the UE may transmit a second SR on a second SR resource if configured. However, the transmission of the second SR may be redundant and unnecessary. For example, the UE may transmit a BFR MAC CE indicating each failed TRP of an SCell and the corresponding candidate beam information via the uplink resource associated with the first SR. When another uplink grant resource is received due to the second SR, it may waste power if the UE transmits the BFR MAC CE again. Thus, the granted uplink resource associated with the second triggered SR is unnecessary. Furthermore, UE power may be used to transmit a redundant SR so long as UE can get the UL resource from network. Still further, ambiguity may arise on the network side if the UE transmits the redundant SR using a dedicated SR resource for BFR.

Some techniques described herein provide resource configuration and signaling procedures for two dedicated SR configurations, such as for mTRP BFR. For example, a UE may be configured with a first SR configuration and a second SR configuration. If the UE detects beam failure associated with a first communication node (e.g., a first TRP), the UE may transmit a first SR on a first SR resource indicated by the first SR configuration. In some aspects, the first SR configuration may be associated with the first communication node. In some other aspects, the first SR configuration may not be associated with the first communication node. If the UE subsequently detects another beam failure associated with a second communication node, the UE may selectively transmit a second SR on a second SR resource indicated by the second SR configuration. In some aspects, the UE may selectively transmit the second SR based at least in part on a timer or multiple timers. In some other aspects, the UE may not transmit (e.g., may refrain from transmitting) the second SR. In this way, redundant signaling is reduced, power consumption is reduced, and ambiguity on the network side is reduced.

As indicated above, FIG. 6 is provided as an example. Other examples may differ from what is described with regard to FIG. 6.

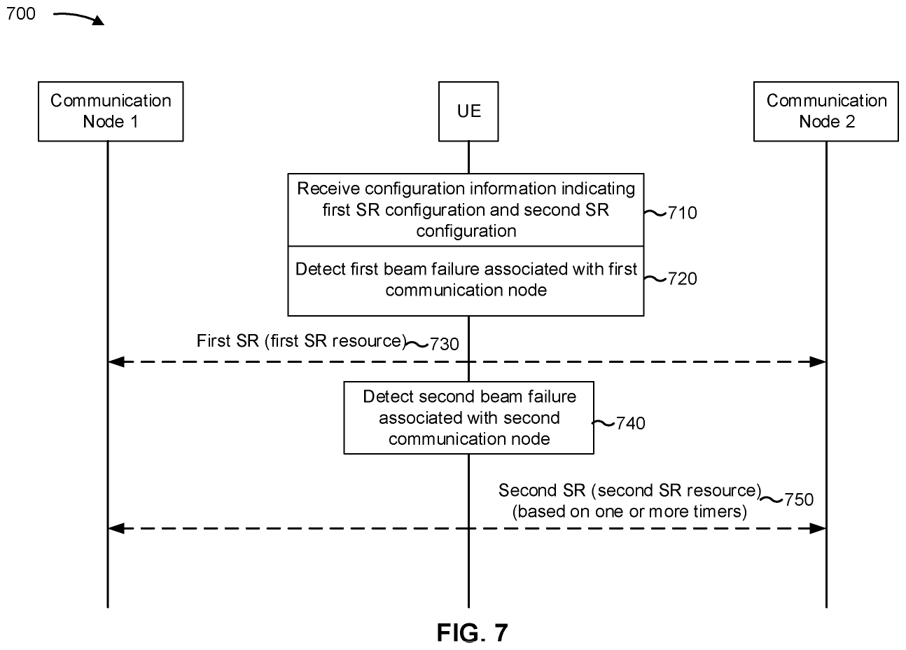

FIG. 7 is a diagram illustrating an example 700 of signaling associated with multi-TRP BFR, in accordance with the present disclosure. Example 700 includes a UE (e.g., UE 120), a first communication node (e.g., BS 110, TRP 335/405/505), and a second communication node (e.g., BS 110, TRP 335/405/505). In some aspects, the first communication node and the second communication node may be TRPs associated with a base station (e.g., gNB). In example 700, communications described as being performed by the base station may be performed by the first communication node, the second communication node, or both.

As shown in FIG. 7, and by reference number 710, the UE may receive configuration information. In some aspects, the UE may receive the configuration information from the base station, such as via RRC signaling. As shown, the configuration information may indicate a first SR configuration and a second SR configuration. Thus, the configuration information may indicate two dedicated SR configurations associated with BFR. In some aspects, the configuration information may be configured for a MAC cell group of the UE. As used herein, an SR configuration may refer to an SR configuration (e.g., schedulingRequestConfig), an SR resource configuration (e.g., schedulingRequestResourceConfig), or the like. An SR configuration may be associated with BFR based at least in part on an SR identifier configuration (e.g., schedulingRequestID-BFR-SCell) associated with the SR configuration.

In some aspects, the first SR configuration includes or is associated with a first identifier associated with the first communication node and the second SR configuration includes or is associated with a second identifier associated with the second communication node. For example, a SchedulingRequestConfig IE (e.g., an SR configuration) may be associated with a schedulingRequestId parameter. The schedulingRequestConfig IE may be associated with or include an identifier such as a TRP identifier associated with a corresponding communication node. The SchedulingRequestConfig IE may also be associated with or include various other parameters, such as sr-ProhibitTimer, sr-TransMax, and/or SR COUNTER. In some aspects, the SchedulingRequestConfig IE may include the identifier.

In some aspects, the first SR configuration is associated with a first SR identifier parameter associated with the first communication node and the second SR configuration is associated with a second SR identifier parameter associated with the second communication node. For example, the UE may receive a first SR identifier parameter associated with the first communication node (for example, a schedulingRequestID-BFR-SCell-TRP1 parameter) and a second SR identifier parameter associated with the second communication node (for example, a schedulingRequestID-BFR-SCell-TRP2 parameter). Thus, a different dedicated schedulingRequestID-BFR-SCell parameter is specified for each TRP (e.g., communication node). Each SR configuration, of the first SR configuration and the second SR configuration, may be associated with a corresponding SR identifier parameter, such as based at least in part on a SchedulingRequestId value of each SR configuration.

In some aspects, the first SR configuration and the second SR configuration are not explicitly associated with either the first communication node or the second communication node. For example, the first SR configuration and the second SR configuration may not include a TRP index associated with a given SR for BFR. In this example, a UE may be configured with a first SR configuration or parameter (e.g., a schedulingRequestID-BFR-SCell-r16 parameter) and a second SR configuration or parameter (e.g., a schedulingRequestID-BFR-SCell-TRP-r17 parameter), which may not be explicitly associated with the first communication node or the second communication node. In some aspects, the first SR configuration may indicate one of schedulingRequestID-BFR-SCell-r16 and schedulingRequestID-BFR-SCell-TRP-r17, and the second SR configuration may indicate the other of schedulingRequestID-BFR-SCell-r16 and schedulingRequestID-BFR-SCell-TRP-r17.

As shown by reference number 720, the UE may detect a first beam failure associated with the first communication node. For example, the UE may detect beam failure associated with an SCell, as described in more detail in connection with FIG. 6. As shown by reference number 730, the UE may transmit a first SR on a first SR resource. For example, the UE may transmit the first SR based at least in part on detecting the first beam failure. In some aspects, the UE may transmit the first SR based at least in part on there being no uplink resource available for transmission of the BFR MAC-CE after detecting the first beam failure. As shown, the first SR can be transmitted to either of the first communication node or the second communication node.

The first SR resource may be configured by or associated with the first SR configuration. For example, the first SR may be transmitted on a PUCCH-SR resource configured by an SR resource configuration associated with the first SR configuration. In some aspects, the first SR is transmitted on the first SR resource based at least in part on the first SR configuration including a first identifier associated with the first communication node. For example, the first SR may be transmitted on an SR resource associated with a TRP index associated with the first communication node. The SR resource may be associated with the TRP index associated with the first communication based at least in part on a TRP identifier in an SR configuration (e.g., SchedulingRequestConfig). In some aspects, the first SR may be transmitted on the first SR resource based at least in part on the first SR configuration being associated with a second SR identifier parameter associated with the first communication node. For example, the first SR configuration may be associated with the first communication node by an SR identifier parameter (e.g., schedulingRequestID-BFR-SCell-TRPX, where X is associated with the first communication node). In some aspects, the SR resource may not be explicitly associated with the first communication node. For example, the SR resource may be associated with one of a schedulingRequestID-BFR-SCell-r16 parameter or a schedulingRequestID-BFR-SCell-r17 parameter which are not explicitly linked to a particular communication node.

As shown by reference number 740, the UE may detect a second beam failure associated with the second communication node. For example, the UE may detect beam failure associated with the same SCell or a different SCell than the first beam failure, as described in more detail in connection with FIG. 6.

As shown by reference number 750, the UE may selectively transmit a second SR on the second SR resource (as indicated by the dashed arrow). For example, the UE may transmit (or may determine not to transmit and/or may not transmit) the second SR based at least in part on detecting the second beam failure. As shown, the second SR can be transmitted to either of the first communication node or the second communication node.

In some aspects, the UE may not transmit or trigger the second SR, even when the second beam failure is detected in the second communication node (e.g., of the same SCell or a different SCell) and BFR is triggered for the second TRP accordingly. This may be beneficial in the case where the first SR configuration and the second SR configuration are not explicitly associated with a communication node. In such examples, the UE may select which SR resource associated with a corresponding SR configuration is to be used to transmit the SR. In this way, the UE may avoid transmitting the second SR.

In some aspects, the second beam failure may be detected before the UE receives a grant associated with the first SR. In such examples, the UE may transmit the second SR if two SR resources (e.g., the first SR resource and the second SR resource) are configured. For example, the second SR resource may be associated with a TRP identifier of the second communication node. As another example, the second SR resource may be associated with the second communication node (e.g., based at least in part on the second SR configuration being associated with the second communication node). As yet another example, the second SR resource may not be explicitly associated with the second communication node.

As shown, in some aspects, the UE may selectively transmit the second SR on the second SR resource based at least in part on one or more timers. For example, in some aspects, the one or more timers may include an SR prohibit timer. An SR prohibit timer may be configured as part of an SR configuration (such as via a parameter sr-ProhibitTimer configured under SchedulingRequestConfig). Generally, an SR prohibit timer may indicate a length of time, after transmitting an SR, within which the UE is not permitted to transmit another SR. In other words, if the SR prohibit timer is active, the UE may not transmit an SR. Examples of SR prohibit timer usage for multi-TRP SR signaling are provided below.

In some aspects, the UE may transmit the SR if a timer (e.g., of the one or more timers) associated with a corresponding communication node is not active. For example, an SR prohibit timer may maintain an SR transmission prohibition for a particular communication node. In such examples, the sr-ProhibitTimer for each communication node may be independently controlled under (e.g., configured by) each SR configuration. The SR configuration may be associated with TRP information (e.g., a TRP identifier or the like). The UE may start the respective sr-ProhibitTimer once the corresponding SR is transmitted via the PUCCH-SR resource configured in the SR configuration associated with the scheduling request identifier. In some aspects, the UE shall start the respective sr-ProhibitTimer once the corresponding SR is transmitted via the PUCCH-SR resource configured in the SR configuration associated with the scheduling request identifier. The UE may cancel the pending SR and stop the respective sr-ProhibitTimer(s) associated with the failed communication node, if the BFR MAC-CE contains beam failure information of the failed TRP information.

In some aspects, the one or more timers include a first timer associated with the first SR configuration and a second timer associated with the second SR configuration. For example, the first SR configuration may configure a first timer (e.g., a first SR prohibit timer) and the second SR configuration may configure a second timer (e.g., a second SR prohibit timer). In such examples, the SR prohibit timer may be coordinated between the first SR configuration and the second SR configuration. For example, the UE may transmit the second SR only if neither timer of the first timer and the second timer is active. Thus, the UE may check the status of both the first timer and the second timer before transmitting the second SR. In such examples, the UE may transmit the second SR based at least in part on no timer associated with an SR configuration associated with BFR being active. In some aspects, the UE may start a timer (of the first timer and the second timer) once an SR is transmitted via an SR resource (e.g., a PUCCH-SR resource) configured in or associated with the SR configuration (e.g., the SR configuration that configures the timer) associated with an SR identifier of the SR. The UE may stop (e.g., deactivate) a timer associated with a failed TRP if a transmitted BFR MAC-CE contains beam failure information of the failed TRP information.

In some aspects, the one or more timers include a shared timer associated with the first SR configuration and the second SR configuration. For example, the base station may configure a shared timer if two SR resources are configured. In some aspects, the shared timer may be used if an existing SR prohibit timer (such as may be configured under the SchedulingRequestConfig IE) is disabled, not configured, or configured and ignored. In some aspects, the shared timer is configured for a MAC cell group of the UE. Additionally, or alternatively, the shared timer may be associated with all SR configurations associated with BFR of the UE (e.g., the first SR configuration and the second SR configuration). In some aspects, the UE may transmit the second SR based at least in part on the shared timer being inactive, or may not transmit the second SR if the shared timer is active. For example, the UE may not be permitted to transmit an SR associated with any SR resource (for multi-TRP BFR) if the shared timer is running. The UE may be permitted to transmit the SR only when the shared timer is not active. The UE may start the shared timer upon transmitting an SR via any configured SR resource (e.g., any dedicated SR resource for multi-TRP BFR. For example, if the UE has transmitted a first SR for BFR for the first communication node (e.g., TRP #1) and if an uplink grant has not been received yet, the UE is not allowed to transmit a second SR for BFR for TRP #2 until the shared timer expires.

In some aspects, the UE may transmit a BFR MAC-CE (not shown). For example, if beam failure is detected on the first TRP and TRP-specific BFR (e.g., BFR associated with the first TRP) is triggered, and if there is an available uplink grant resource, the UE may transmit the BFR MAC-CE via the uplink resource. In some aspects, the UE may receive an uplink grant based at least in part on an SR (e.g., the first SR and/or the second SR) and may transmit the BFR MAC-CE via the uplink grant.

In some aspects, the first SR is triggered, and the first SR is transmitted via a PUCCH-SR resource configured in SchedulingRequestResourceConfig (e.g., an SR resource configuration), when beam failure is detected in a first TRP (e.g., first communication node) and BFR is triggered for the first TRP. The UE may start a shared timer once the first SR is transmitted. If there are available uplink resources, the UE may transmit an mTRP BFR MAC-CE via the uplink resource. Before any indication of a granted resource is received, beam failure may be detected in a second TRP (e.g., communication node) of the same or different SCell, and BFR may be triggered for the second TRP accordingly. The second SR, with corresponding schedulingRequestID (e.g., SR identifier parameter) associated with the second TRP, may not be triggered if the shared timer is running. When the shared timer expires, and if there is still no available uplink resource, the UE may transmit the second SR using the second SR resource. The shared timer may restart after UE transmits the second SR.

As indicated above, FIG. 7 is provided as an example. Other examples may differ from what is described with regard to FIG. 7.

FIG. 8 is a diagram illustrating an example process 800 performed, for example, by a user equipment (UE), in accordance with the present disclosure. Example process 800 is an example where the UE (e.g., UE 120) performs operations associated with resource configuration for scheduling requests.

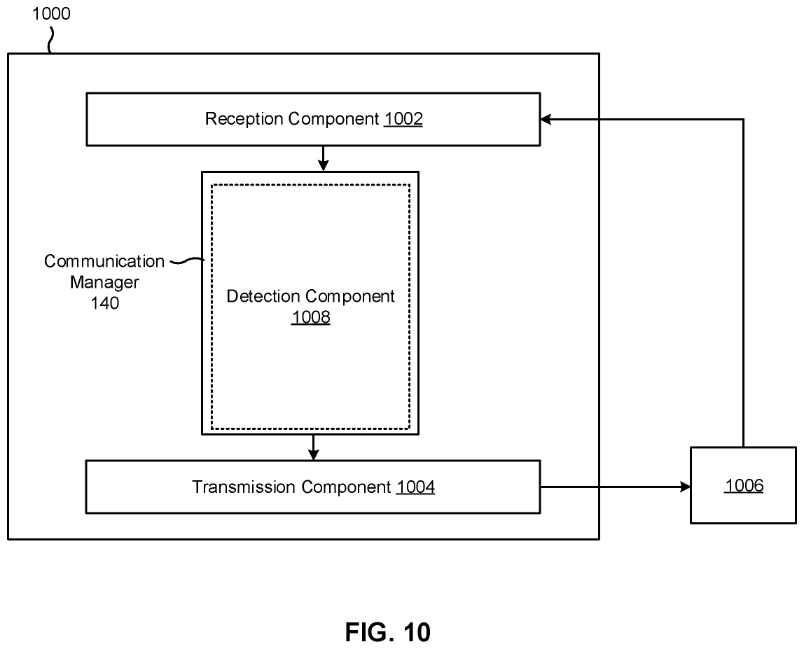

As shown in FIG. 8, in some aspects, process 800 may include receiving configuration information identifying a first SR configuration associated with beam failure recovery (BFR) and a second SR configuration associated with BFR (block 810). For example, the UE (e.g., using communication manager 140 and/or reception component 1002, depicted in FIG. 10) may receive configuration information identifying a first SR configuration associated with BFR and a second SR configuration associated with BFR, as described above.

As further shown in FIG. 8, in some aspects, process 800 may include detecting a first beam failure associated with a first communication node (block 820). For example, the UE (e.g., using communication manager 140 and/or detection component 1008, depicted in FIG. 10) may detect a first beam failure associated with a first communication node, as described above.

As further shown in FIG. 8, in some aspects, process 800 may include transmitting a first SR on a first SR resource indicated by the first SR configuration based at least in part on detecting the first beam failure associated with the first communication node (block 830). For example, the UE (e.g., using communication manager 140 and/or transmission component 1004, depicted in FIG. 10) may transmit a first SR on a first SR resource indicated by the first SR configuration based at least in part on detecting the first beam failure associated with the first communication node, as described above.

As further shown in FIG. 8, in some aspects, process 800 may include detecting a second beam failure associated with a second communication node (block 840). For example, the UE (e.g., using communication manager 140 and/or detection component 1008, depicted in FIG. 10) may detect a second beam failure associated with a second communication node, as described above.

As further shown in FIG. 8, in some aspects, process 800 may include selectively transmitting a second SR on a second SR resource indicated by the second SR configuration based at least in part on detecting the second beam failure associated with the second communication node and the configuration information (block 850). For example, the UE (e.g., using communication manager 140 and/or transmission component 1004, depicted in FIG. 10) may selectively transmit a second SR on a second SR resource indicated by the second SR configuration based at least in part on detecting the second beam failure associated with the second communication node and the configuration information, as described above.

Process 800 may include additional aspects, such as any single aspect or any combination of aspects described below and/or in connection with one or more other processes described elsewhere herein.

In a first aspect, selectively transmitting the second SR on the second SR resource further comprises selectively transmitting the second SR on the second SR resource based at least in part on one or more timers.

In a second aspect, alone or in combination with the first aspect, selectively transmitting the second SR on the second SR resource based at least in part on the one or more timers further comprises selectively transmitting the second SR if a timer, of the one or more timers, associated with the second communication node is inactive.

In a third aspect, alone or in combination with one or more of the first and second aspects, the one or more timers include a first timer associated with the first SR configuration and a second timer associated with the second SR configuration, and wherein selectively transmitting the second SR on the second SR resource based at least in part on the one or more timers further comprises transmitting the second SR only if neither timer of the first timer and the second timer is active.

In a fourth aspect, alone or in combination with one or more of the first through third aspects, selectively transmitting the second SR on the second SR resource based at least in part on the one or more timers further comprises transmitting the second SR based at least in part on no timer associated with an SR configuration associated with BFR being active.

In a fifth aspect, alone or in combination with one or more of the first through fourth aspects, the one or more timers include a shared timer associated with the first SR configuration and the second SR configuration.

In a sixth aspect, alone or in combination with one or more of the first through fifth aspects, the shared timer is configured for a MAC cell group of the UE.

In a seventh aspect, alone or in combination with one or more of the first through sixth aspects, selectively transmitting the second SR on the second SR resource based at least in part on the one or more timers further comprises transmitting the second SR based at least in part on the shared timer being inactive.

In an eighth aspect, alone or in combination with one or more of the first through seventh aspects, the shared timer is associated with all SR configurations associated with BFR of the UE.

In a ninth aspect, alone or in combination with one or more of the first through eighth aspects, process 800 includes activating the shared timer based at least in part on transmitting the first SR or the second SR.

The method of claim 6, wherein, based at least in part on the shared timer being configured, an SR prohibit timer is disabled, not configured, or configured and ignored.

In a tenth aspect, alone or in combination with one or more of the first through ninth aspects, selectively transmitting the second SR comprises refraining from transmitting the second SR.

In an eleventh aspect, alone or in combination with one or more of the first through tenth aspects, the first SR configuration includes a first identifier associated with the first communication node and the second SR configuration includes a second identifier associated with the second communication node.

In a twelfth aspect, alone or in combination with one or more of the first through eleventh aspects, the first SR configuration is associated with a first SR identifier parameter associated with the first communication node and the second SR configuration is associated with a second SR identifier parameter associated with the second communication node.

In a thirteenth aspect, alone or in combination with one or more of the first through twelfth aspects, the first SR configuration and the second SR configuration are not explicitly associated with either the first communication node or the second communication node.

In a fourteenth aspect, alone or in combination with one or more of the first through thirteenth aspects, transmitting the first SR on the first SR resource indicated by the first SR configuration comprises transmitting the first SR on the first SR resource based at least in part on the first SR configuration including a first identifier associated with the first communication node.

In a fifteenth aspect, alone or in combination with one or more of the first through fourteenth aspects, transmitting the first SR on the first SR resource indicated by the first SR configuration comprises transmitting the first SR on the first SR resource based at least in part on the first SR configuration being associated with the first communication node.

In a sixteenth aspect, alone or in combination with one or more of the first through fifteenth aspects, the second SR is transmitted on the second SR resource based at least in part on the first SR having been transmitted on the first SR resource, the second beam failure having been detected prior to receiving the uplink grant resource associated with the first SR, and the second SR configuration including an identifier associated with the second communication node.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram illustrating an example process 900 performed, for example, by a base station, in accordance with the present disclosure. Example process 900 is an example where the base station (e.g., base station 110) performs operations associated with resource configuration for scheduling requests.

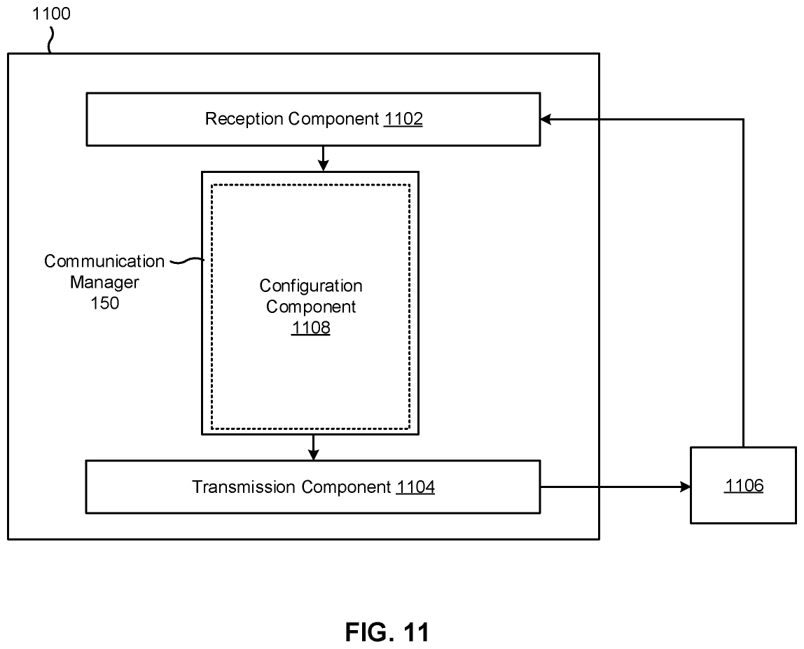

As shown in FIG. 9, in some aspects, process 900 may include transmitting configuration information identifying a first scheduling request (SR) resource configuration associated with beam failure recovery (BFR) and a second SR configuration associated with BFR (block 910). For example, the base station (e.g., using communication manager 150 and/or transmission component 1104, depicted in FIG. 11) may transmit configuration information identifying a first scheduling request (SR) resource configuration associated with beam failure recovery (BFR) and a second SR configuration associated with BFR, as described above.

As further shown in FIG. 9, in some aspects, process 900 may include receiving a first SR on a first SR resource indicated by the first SR configuration based at least in part on a beam failure associated with a first communication node of the base station (block 920). For example, the base station (e.g., using communication manager 150 and/or reception component 1102, depicted in FIG. 11) may receive a first SR on a first SR resource indicated by the first SR configuration based at least in part on a beam failure associated with a first communication node of the base station, as described above.

As further shown in FIG. 9, in some aspects, process 900 may include selectively receiving a second SR on a second SR resource indicated by the second SR configuration based at least in part on a second beam failure associated with a second communication node of the base station, and based at least in part on the configuration information (block 930). For example, the base station (e.g., using communication manager 150 and/or reception component 1102, depicted in FIG. 11) may selectively receive a second SR on a second SR resource indicated by the second SR configuration based at least in part on a second beam failure associated with a second communication node of the base station, and based at least in part on the configuration information, as described above.

Process 900 may include additional aspects, such as any single aspect or any combination of aspects described below and/or in connection with one or more other processes described elsewhere herein.

In a first aspect, selectively receiving the second SR on the second SR resource further comprises selectively receiving the second SR on the second SR resource based at least in part on one or more timers.

In a second aspect, alone or in combination with the first aspect, process 900 includes configuring the one or more timers.

In a third aspect, alone or in combination with one or more of the first and second aspects, the first SR configuration is a first SR configuration that includes a first identifier associated with the first communication node and the second SR configuration is a second SR configuration that includes a second identifier associated with the second communication node.

In a fourth aspect, alone or in combination with one or more of the first through third aspects, the first SR configuration and the second SR configuration are not explicitly associated with either the first communication node or the second communication node.

In a fifth aspect, alone or in combination with one or more of the first through fourth aspects, the first SR configuration is implicitly associated with the first communication node and the second SR configuration is implicitly associated with the second communication node.

In a sixth aspect, alone or in combination with one or more of the first through fifth aspects, receiving the first SR on the first SR resource indicated by the first SR configuration comprises receiving the first SR on the first SR resource based at least in part on the first SR configuration including a first identifier associated with the first communication node.

In a seventh aspect, alone or in combination with one or more of the first through sixth aspects, receiving the first SR on the first SR resource indicated by the first SR configuration comprises receiving the first SR on the first SR resource based at least in part on the first SR configuration being associated with the first communication node.

In an eighth aspect, alone or in combination with one or more of the first through seventh aspects, the second SR is transmitted on the second SR resource based at least in part on the first SR having been transmitted on the first SR resource, the second beam failure being detected prior to receiving the uplink grant resource associated with the first SR, and the second SR configuration including an identifier associated with the second communication node.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram of an example apparatus 1000 for wireless communication, in accordance with the present disclosure. The apparatus 1000 may be a UE, or a UE may include the apparatus 1000. In some aspects, the apparatus 1000 includes a reception component 1002 and a transmission component 1004, which may be in communication with one another (for example, via one or more buses and/or one or more other components). As shown, the apparatus 1000 may communicate with another apparatus 1006 (such as a UE, a base station, or another wireless communication device) using the reception component 1002 and the transmission component 1004. As further shown, the apparatus 1000 may include the communication manager 140. The communication manager 140 may include a detection component 1008, among other examples.

In some aspects, the apparatus 1000 may be configured to perform one or more operations described herein in connection with FIGS. 3-7. Additionally, or alternatively, the apparatus 1000 may be configured to perform one or more processes described herein, such as process 800 of FIG. 8, or a combination thereof. In some aspects, the apparatus 1000 and/or one or more components shown in FIG. 10 may include one or more components of the UE described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1006. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the UE described in connection with FIG. 2.

The transmission component 1004 may transmit communications, such as reference signals, control information, data communications, or a combination thereof, to the apparatus 1006. In some aspects, one or more other components of the apparatus 1000 may generate communications and may provide the generated communications to the transmission component 1004 for transmission to the apparatus 1006. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1006. In some aspects, the transmission component 1004 may include one or more antennas, a modem, a modulator, a transmit MIMO processor, a transmit processor, a controller/processor, a memory, or a combination thereof, of the UE described in connection with FIG. 2. In some aspects, the transmission component 1004 may be co-located with the reception component 1002 in a transceiver.

The reception component 1002 may receive configuration information identifying a first scheduling request (SR) resource configuration associated with beam failure recovery (BFR) and a second SR configuration associated with BFR. The detection component 1008 may detect a first beam failure associated with a first communication node. The transmission component 1004 may transmit a first SR on a first SR resource indicated by the first SR configuration based at least in part on detecting the first beam failure associated with the first communication node. The detection component 1008 may detect a second beam failure associated with a second communication node. The transmission component 1004 may selectively transmit a second SR on a second SR resource indicated by the second SR configuration based at least in part on detecting the second beam failure associated with the second communication node and the configuration information.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

FIG. 11 is a diagram of an example apparatus 1100 for wireless communication, in accordance with the present disclosure. The apparatus 1100 may be a base station, or a base station may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 150. The communication manager 150 may include a configuration component 1108, among other examples.

In some aspects, the apparatus 1100 may be configured to perform one or more operations described herein in connection with FIGS. 3-7. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the base station described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the base station described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the base station described in connection with FIG. 2. In some aspects, the transmission component 1104 may be co-located with the reception component 1102 in a transceiver.

The transmission component 1104 or the configuration component 1108 may transmit configuration information identifying a first scheduling request (SR) resource configuration associated with beam failure recovery (BFR) and a second SR configuration associated with BFR. The reception component 1102 may receive a first SR on a first SR resource indicated by the first SR configuration based at least in part on a beam failure associated with a first communication node of the base station. The reception component 1102 may selectively receive a second SR on a second SR resource indicated by the second SR configuration based at least in part on a second beam failure associated with a second communication node of the base station, and based at least in part on the configuration information.

The configuration component 1108 may configure the one or more timers.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

The following provides an overview of some Aspects of the present disclosure:

Aspect 1: A method of wireless communication performed by a user equipment (UE), comprising: receiving configuration information identifying a first scheduling request (SR) resource configuration associated with beam failure recovery (BFR) and a second SR configuration associated with BFR; detecting a first beam failure associated with a first communication node; transmitting a first SR on a first SR resource indicated by the first SR configuration based at least in part on detecting the first beam failure associated with the first communication node; detecting a second beam failure associated with a second communication node; and selectively transmitting a second SR on a second SR resource indicated by the second SR configuration based at least in part on detecting the second beam failure associated with the second communication node and the configuration information.

Aspect 2: The method of Aspect 1, wherein selectively transmitting the second SR on the second SR resource further comprises selectively transmitting the second SR on the second SR resource based at least in part on one or more timers.

Aspect 3: The method of Aspect 2, wherein selectively transmitting the second SR on the second SR resource based at least in part on the one or more timers further comprises selectively transmitting the second SR if a timer, of the one or more timers, associated with the second communication node is inactive.

Aspect 4: The method of Aspect 2, wherein the one or more timers include a first timer associated with the first SR configuration and a second timer associated with the second SR configuration, and wherein selectively transmitting the second SR on the second SR resource based at least in part on the one or more timers further comprises transmitting the second SR only if neither timer of the first timer and the second timer is active.

Aspect 5: The method of Aspect 4, wherein selectively transmitting the second SR on the second SR resource based at least in part on the one or more timers further comprises transmitting the second SR based at least in part on no timer associated with an SR configuration associated with BFR being active.

Aspect 6: The method of Aspect 2, wherein the one or more timers include a shared timer associated with the first SR configuration and the second SR configuration.

Aspect 7: The method of Aspect 6, wherein the shared timer is configured for a MAC cell group of the UE.

Aspect 8: The method of Aspect 6, wherein selectively transmitting the second SR on the second SR resource based at least in part on the one or more timers further comprises transmitting the second SR based at least in part on the shared timer being inactive.

Aspect 9: The method of Aspect 6, wherein the shared timer is associated with all SR configurations associated with BFR of the UE.

Aspect 10: The method of Aspect 6, further comprising activating the shared timer based at least in part on transmitting the first SR or the second SR.

Aspect 11: The method of Aspect 6, wherein, based at least in part on the shared timer being configured, an SR prohibit timer is disabled, not configured, or configured and ignored.

Aspect 12: The method of any of Aspects 1-11, wherein selectively transmitting the second SR comprises refraining from transmitting the second SR.

Aspect 13: The method of any of Aspects 1-12, wherein the first SR configuration includes a first identifier associated with the first communication node and the second SR configuration includes a second identifier associated with the second communication node.

Aspect 14: The method of any of Aspects 1-13, wherein the first SR configuration is associated with a first SR identifier parameter associated with the first communication node and the second SR configuration is associated with a second SR identifier parameter associated with the second communication node.

Aspect 15: The method of any of Aspects 1-14, wherein the first SR configuration and the second SR configuration are not explicitly associated with either the first communication node or the second communication node.

Aspect 16: The method of any of Aspects 1-15, wherein transmitting the first SR on the first SR resource indicated by the first SR configuration comprises: transmitting the first SR on the first SR resource based at least in part on the first SR configuration including a first identifier associated with the first communication node.

Aspect 17: The method of any of Aspects 1-16, wherein transmitting the first SR on the first SR resource indicated by the first SR configuration comprises: transmitting the first SR on the first SR resource based at least in part on the first SR configuration being associated with the first communication node.

Aspect 18: The method of any of Aspects 1-17, wherein the second SR is transmitted on the second SR resource based at least in part on the first SR having been transmitted on the first SR resource, the second beam failure having been detected prior to receiving the uplink grant resource associated with the first SR, and the second SR configuration including an identifier associated with the second communication node.

Aspect 19: A method of wireless communication performed by a base station, comprising: transmitting configuration information identifying a first scheduling request (SR) resource configuration associated with beam failure recovery (BFR) and a second SR configuration associated with BFR; receiving a first SR on a first SR resource indicated by the first SR configuration based at least in part on a beam failure associated with a first communication node of the base station; and selectively receiving a second SR on a second SR resource indicated by the second SR configuration based at least in part on a second beam failure associated with a second communication node of the base station, and based at least in part on the configuration information.

Aspect 20: The method of Aspect 19, wherein selectively receiving the second SR on the second SR resource further comprises selectively receiving the second SR on the second SR resource based at least in part on one or more timers.

Aspect 21: The method of Aspect 20, further comprising configuring the one or more timers.

Aspect 22: The method of any of Aspects 19-21, wherein the first SR configuration includes a first identifier associated with the first communication node and the second SR configuration includes a second identifier associated with the second communication node.

Aspect 23: The method of any of Aspects 19-22, wherein the first SR configuration and the second SR configuration are not explicitly associated with either the first communication node or the second communication node.

Aspect 24: The method of any of Aspects 19-23, wherein the first SR configuration is implicitly associated with the first communication node and the second SR configuration is implicitly associated with the second communication node.

Aspect 25: The method of any of Aspects 19-24, wherein receiving the first SR on the first SR resource indicated by the first SR configuration comprises: receiving the first SR on the first SR resource based at least in part on the first SR configuration including a first identifier associated with the first communication node.

Aspect 26: The method of any of Aspects 19-25, wherein receiving the first SR on the first SR resource indicated by the first SR configuration comprises: receiving the first SR on the first SR resource based at least in part on the first SR configuration being associated with the first communication node.

Aspect 27: The method of any of Aspects 19-26, wherein the second SR is transmitted on the second SR resource based at least in part on the first SR having been transmitted on the first SR resource, the second beam failure being detected prior to receiving the uplink grant resource associated with the first SR, and the second SR configuration including an identifier associated with the second communication node.

Aspect 28: An apparatus for wireless communication at a device, comprising a processor; memory coupled with the processor; and instructions stored in the memory and executable by the processor to cause the apparatus to perform the method of one or more of Aspects 1-27.

Aspect 29: A device for wireless communication, comprising a memory and one or more processors coupled to the memory, the one or more processors configured to perform the method of one or more of Aspects 1-27.

Aspect 30: An apparatus for wireless communication, comprising at least one means for performing the method of one or more of Aspects 1-27.

Aspect 31: A non-transitory computer-readable medium storing code for wireless communication, the code comprising instructions executable by a processor to perform the method of one or more of Aspects 1-27.

Aspect 32: A non-transitory computer-readable medium storing a set of instructions for wireless communication, the set of instructions comprising one or more instructions that, when executed by one or more processors of a device, cause the device to perform the method of one or more of Aspects 1-27.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
a memory; and
one or more processors, coupled to the memory, configured to:
receive configuration information identifying a first scheduling request (SR) configuration associated with beam failure recovery (BFR) and a second SR configuration associated with BFR;
detect a first beam failure associated with a first communication node;
transmit a first SR on a first SR resource indicated by the first SR configuration based at least in part on detecting the first beam failure associated with the first communication node;
detect a second beam failure associated with a second communication node; and
selectively transmit a second SR on a second SR resource indicated by the second SR configuration based at least in part on detecting the second beam failure associated with the second communication node and the configuration information.

2. The UE of claim 1, wherein the one or more processors, to selectively transmit the second SR on the second SR resource, are configured to selectively transmit the second SR on the second SR resource based at least in part on one or more timers.

3. The UE of claim 2, wherein the one or more processors, to selectively transmit the second SR on the second SR resource based at least in part on the one or more timers, are configured to selectively transmit the second SR if a timer, of the one or more timers, associated with the second communication node is inactive.

4. The UE of claim 2, wherein the one or more timers include a first timer associated with the first SR configuration and a second timer associated with the second SR configuration, and wherein selectively transmitting the second SR on the second SR resource based at least in part on the one or more timers further comprises transmitting the second SR only if neither timer of the first timer and the second timer is active.

5. The UE of claim 4, wherein the one or more processors, to selectively transmit the second SR on the second SR resource based at least in part on the one or more timers, are configured to transmit the second SR based at least in part on no timer associated with an SR configuration associated with BFR being active.

6. The UE of claim 2, wherein the one or more timers include a shared timer associated with the first SR configuration and the second SR configuration.

7. The UE of claim 6, wherein the shared timer is configured for a MAC cell group of the UE.

8. The UE of claim 6, wherein the one or more processors, to selectively transmit the second SR on the second SR resource based at least in part on the one or more timers, are configured to transmit the second SR based at least in part on the shared timer being inactive.

9. The UE of claim 6, wherein the shared timer is associated with all SR configurations associated with BFR of the UE.

10. The UE of claim 6, wherein the one or more processors are further configured to activate the shared timer based at least in part on transmitting the first SR or the second SR.

11. The UE of claim 6, wherein, based at least in part on the shared timer being configured, an SR prohibit timer is disabled, not configured, or configured and ignored.

12. The UE of claim 1, wherein the one or more processors, to selectively transmit the second SR, are configured to refrain from transmitting the second SR.

13. The UE of claim 1, wherein the first SR configuration includes a first identifier associated with the first communication node and the second SR configuration includes a second identifier associated with the second communication node.

14. The UE of claim 1, wherein the first SR configuration is associated with a first SR identifier parameter associated with the first communication node and the second SR configuration is associated with a second SR identifier parameter associated with the second communication node.

15-16. (canceled)

17. The UE of claim 1, wherein the one or more processors, to transmit the first SR on the first SR resource indicated by the first SR configuration, are configured to:
transmit the first SR on the first SR resource based at least in part on the first SR configuration being associated with the first communication node.

18. (canceled)

19. A base station for wireless communication, comprising:
a memory; and
one or more processors, coupled to the memory, configured to:
transmit configuration information identifying a first scheduling request (SR) resource configuration associated with beam failure recovery (BFR) and a second SR configuration associated with BFR;
receive a first SR on a first SR resource indicated by the first SR configuration based at least in part on a beam failure associated with a first communication node of the base station; and
selectively receive a second SR on a second SR resource indicated by the second SR configuration based at least in part on a second beam failure associated with a second communication node of the base station, and based at least in part on the configuration information.

20. The base station of claim 19, wherein the one or more processors, to selectively receive the second SR on the second SR resource, are configured to selectively receive the second SR on the second SR resource based at least in part on one or more timers.

21-23. (canceled)

24. The base station of claim 19, wherein the one or more processors, to receive the first SR on the first SR resource indicated by the first SR configuration, are configured to:
receive the first SR on the first SR resource based at least in part on the first SR configuration including a first identifier associated with the first communication node.

25. The base station of claim 19, wherein the one or more processors, to receive the first SR on the first SR resource indicated by the first SR configuration, are configured to:
receive the first SR on the first SR resource based at least in part on the first SR configuration being associated with the first communication node.

26. The base station of claim 19, wherein the second SR is transmitted on the second SR resource based at least in part on the first SR having been transmitted on the first SR resource, the second beam failure being detected prior to transmitting an uplink grant for a resource associated with the first SR, and the second SR configuration including an identifier associated with the second communication node.

27. A method of wireless communication performed by a user equipment (UE), comprising:
receiving configuration information identifying a first scheduling request (SR) configuration associated with beam failure recovery (BFR) and a second SR configuration associated with BFR;
detecting a first beam failure associated with a first communication node;
transmitting a first SR on a first SR resource indicated by the first SR configuration based at least in part on detecting the first beam failure associated with the first communication node;
detecting a second beam failure associated with a second communication node; and
selectively transmitting a second SR on a second SR resource indicated by the second SR configuration based at least in part on detecting the second beam failure associated with the second communication node and the configuration information.

28. The method of claim 27, wherein selectively transmitting the second SR on the second SR resource further comprises selectively transmitting the second SR on the second SR resource based at least in part on one or more timers.

29-31. (canceled)

32. The method of claim 27, wherein the first SR configuration includes a first identifier associated with the first communication node and the second SR configuration includes a second identifier associated with the second communication node.

33. The method of claim 27, wherein the first SR configuration is associated with a first SR identifier parameter associated with the first communication node and the second SR configuration is associated with a second SR identifier parameter associated with the second communication node.

34. The method of claim 27, wherein the first SR configuration and the second SR configuration are not explicitly associated with either the first communication node or the second communication node.

35. The method of claim 27, wherein transmitting the first SR on the first SR resource indicated by the first SR configuration comprises:
transmitting the first SR on the first SR resource based at least in part on the first SR configuration including a first identifier associated with the first communication node.

36. The method of claim 27, wherein transmitting the first SR on the first SR resource indicated by the first SR configuration comprises:
transmitting the first SR on the first SR resource based at least in part on the first SR configuration being associated with the first communication node.

37. A method of wireless communication performed by a base station, comprising:
transmitting configuration information identifying a first scheduling request (SR) resource configuration associated with beam failure recovery (BFR) and a second SR configuration associated with BFR;
receiving a first SR on a first SR resource indicated by the first SR configuration based at least in part on a beam failure associated with a first communication node of the base station; and
selectively receiving a second SR on a second SR resource indicated by the second SR configuration based at least in part on a second beam failure associated with a second communication node of the base station, and based at least in part on the configuration information.

38. The method of claim 37, wherein selectively receiving the second SR on the second SR resource further comprises selectively receiving the second SR on the second SR resource based at least in part on one or more timers.

39-41. (canceled)
